(19) United States
(12) Patent Application Publication
(10) Pub. No.: US 2017/0206535 A1
(43) Pub. Date: Jul. 20, 2017

(54) AUTHENTICATION BASED ON DATA CONTENT AND DATA PARTITIONS

(71) Applicant: Hewlett-Packard Development Company, L.P., Fort Collins, CO (US)

(72) Inventors: Matthew D GAUBATZ, Seattle, WA (US); Steven J SIMSKE, Fort fCollins, CO (US); Robert ULICHNEY, Stow, MA (US)

(21) Appl. No.: 15/304,825

(22) PCT Filed: Apr. 17, 2014
(86) PCT No.: PCT/US2014/034519

§ 371 Date: Oct. 17, 2016

(51) Int. Cl. G06Q 30/00; G06K 19/06; G06K 19/10

(52) U.S. Cl. CPC G06Q 30/0185; G06K 19/10; G06K 19/06028; G06K 19/06037

(57) ABSTRACT

Examples disclosed herein relate to authentication based on data content and data partitions. In one implementation, a processor may execute instructions to determine the likelihood of authenticity based on partitions of the authentication data and content of the authentication data. The processor then outputs information related to the likelihood of authenticity.

### BACKGROUND

Authentication methods may be used to confirm that a product is associated with an expected source. For example, a package may include a barcode, steganographic halftone, grid code, or other printed image that may include authentication data used to verify that the package is associated with the expected source. If the authentication data is found unlikely to be authentic, counterfeiting may be suspected.

### BRIEF DESCRIPTION OF THE DRAWINGS

The drawings describe example embodiments. The following detailed description references the drawings, wherein:

FIG. 1 is a block diagram of a computing system to determine a likelihood of authenticity based on data content and data partitions.

FIG. 2 is a flow chart illustrating one example of a method to determine a likelihood of authenticity based on data content and data partitions.

FIG. 3 is a diagram illustrating one example of partition information related to authentication data.

FIG. 4A is a block diagram illustrating one example of data pa ions in a steganographic halftone image.

FIGS. 4B-4D illustrate examples of partition mappings that may be compared to a steganographic halftone image to determine likelihood of authenticity.

FIG. 5 is a diagram illustrating one example of determining a likelihood of authenticity based on stored partition authentication information.

FIG. 6A is a diagram illustrating one example of determining a likelihood of authenticity based on data partitions of stored previously authenticated partition information.

FIG. 6B is a diagram illustrating one example of determining a likelihood of authenticity based on an error rate.

### DETAILED DESCRIPTION

In one implementation, authentication is performed by analyzing both authentication data content and the partitioning (such as number, size, and sequence of partitions) of the authentication data. For example, a processor may receive authentication data that is partitioned with a separating character or partitioned together in its appearance. For example, a steganographic halftone “stegatone” image may include multiple cells, and which cells include data, how much data (such as how many bits) included within the data bearing cells, and the content of the data in the data bearing cells may be used to determine whether the authentication data encoded in the halftone is likely to be authentic. The processor may determine whether the authentication data is authenticated based on both the partitioning of the data and the data itself. For example, the authentication determination may be based on the number of partitions and/or the amount of data in each partition. In one implementation, the partitioning of an authentic data string is known, such as where the string is to include four partitions with three bits each. In one implementation, a received authentication string, is compared to previously authenticated strings to determine if the partitioning of the received authentication string is likely to be associated with authentic data.

Using the partition information and the data content to determine a likelihood of authenticity may be useful where the amount of data is constricted, such as due to the constrained amount of data that may be represented by perturbations in a halftone image. For example, it may be otherwise impractical to provide additional authentication data within the authentication string or within a second authentication string due to space and visual requirements,

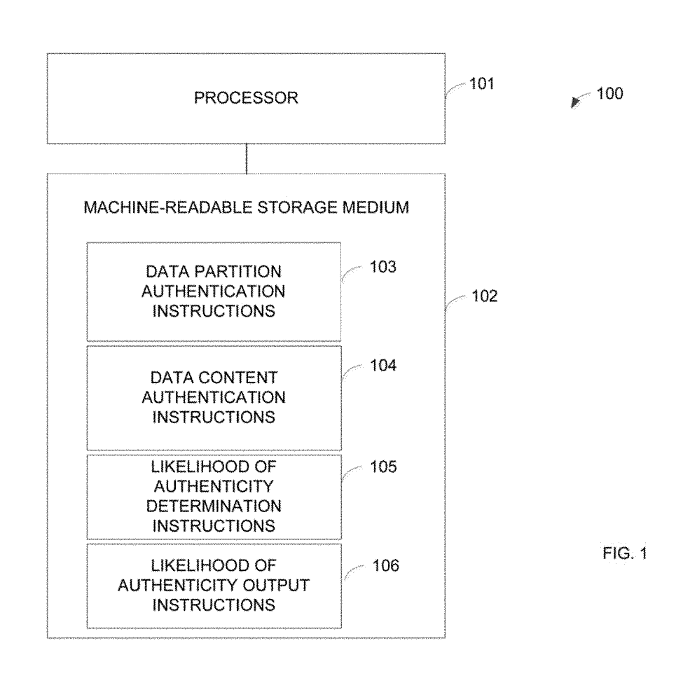

FIG. 1 is a block diagram of a computing system to determine a likelihood of authenticity based on data content and data partitions. The computing system 100 may be used to read authentication data and determine the likelihood of authenticity. For example, the computing system 100 may be associated with a camera to capture an image, such as of a barcode or stegatone, and the computing system 100 may decode the image to determine the associated authentication data. The computing system 100 may determine the likelihood of authenticity of the authentication data based on the data content and the partitioning of the data. The partition authentication data and the content authentication data may be independent. The data may be different lengths. For example, the partition may include three partitions of different amounts of data, and the content authentication data divided into the partitions may include four bits per partition, resulting in 12 bits of data. The computing system 100 may include a processor 101 and a machine-readable storage medium 102.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include data partition authentication instructions 103, data content authentication instructions 104, likelihood of authenticity determination instructions 105, and likelihood of authenticity output instructions 106.

The data partition authentication instructions 103 relate to determining authentication information based on partitions of the authentication data. For example, the processor 101 may communicate with a storage, such as directly or via a network, to retrieve information related to determining the authentication information related to the partitions of the authentication data. In one implementation, the storage stores information related to partitions of authentic data, such as a data partition key. The processor may compare the data partitions of the received authentication data to the stored partition information. The stored partition information may include a partition information specific to a particular type of authentication string or type of user. In one implementation, the processor 101 compares the received authentication data to previously authenticated authentication data and determines information about the likelihood of authenticity of the received data partition based on the similarity to the previously authenticated data and/or similarity to previously unauthenticated data.

The processor may compare the received data partitions to a data partition key or previously authenticated data partitions to determine a degree of similarity. For example, the degree of similarity may be used where the data partitions may have some variation due to data being obfuscated.

The data content authentication instructions 104 may include instructions to determine authentication information based on the content of received authentication data. For example, the content of the data may be compared to a database of known authenticated data or compared to previously authentication data. In some implementations, an operation, such as examination of a digital signature, is performed on the received authentication data to determine if it is likely to be authentic.

The likelihood of authenticity determination instructions 105 may include instructions to determine a likelihood of authenticity of received authentication data based on the data content authentication information and the data partition authentication information. Information about the authenticity of the content of the received data may be determined in conjunction with the partition information or independently. For example, the likelihood of authentication may be based on a partition authentication score and a data authentication score. In one implementation, the data partition is analyzed and portions of the authentication data with a partitioning that is likely to be authentic is further analyzed to determine if the underlying data in those partitions is likely to be authentic. In one implementation, the data is analyzed, and if the data is determined to be likely to be authentic, the partitioning of the data is analyzed. In one implementation, the data is analyzed, and portions of the data determined to be likely to be authentic are further analyzed authenticity information related to the partitions of the portions of the data content found likely to be authentic.

The likelihood of authenticity output instructions 106 may include instructions to store, transmit, or display information about the likelihood of authenticity. In one implementation, the processor determines a binary decision as to whether the data is authentic based on the likelihood of authenticity, such as where a threshold is associated with authentication. In one implementation, the likelihood of authenticity of the data is compared to other factors to determine authenticity.

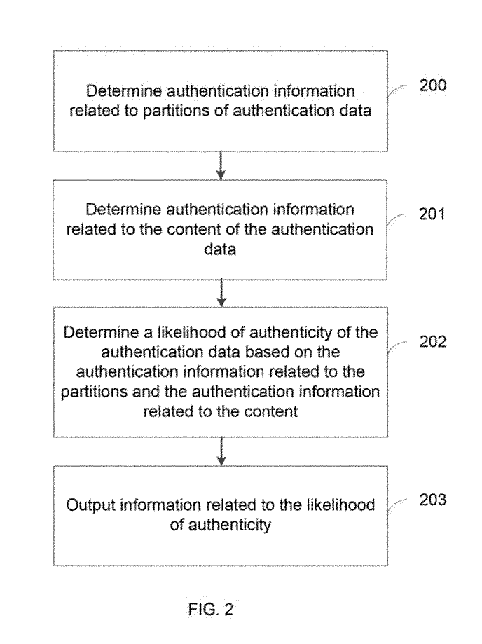

FIG. 2 is a flow chart illustrating one example of a method to determine a likelihood of authenticity based on data content and data partitions. The data may be in the form of a data bearing image, such as a two-dimensional color barcode, progressive barcode, stegatone, grid code, or other digital image. The method may be implemented, for example, by the computing system 100.

Beginning at 200, a processor determines authentication information related to partitions of authentication data. For example, the processor may determine authentication information related to the number of partitions and/or the amount of data in the partitions. The data may be partitioned in any suitable manner, such as based on a delimiter or a position of the data. The processor may communicate with a storage device that stores information about partitions.. For example, the storage may store a key for the number of partitions, a key for the amount of data In each of a number of partitions, partition information related to previously authenticated data, partition information related to previously unauthenticated data, and/or previously received partition information and the associated determined likelihood of authenticity associated with the data with the particular partition information. In one implementation, the processor determines a difference between partition information associated with data compared to stored partition information. For example, the processor may determine a Hamming distance between the two pieces of partition information. The processor may determine a Hamming distance between partition information related to received data compared to multiple pieces of stored partition information, such as where the different partition information is associated with previously analyzed data determined to have a high likelihood of authenticity. The Hamming distances may be aggregated, such as through averaging, to determine authentication information associated with the received data

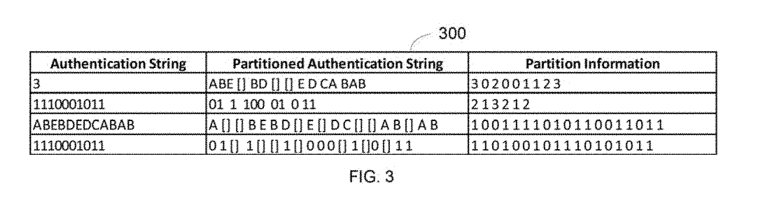

FIG. 3 is a diagram illustrating one example of partition information related to authentication data. Table 3 includes four examples of authentication strings. The authentication strings may include any suitable data, such as binary or other data. The second column shows how the data is partitioned. For example, the data may be grouped together. In some cases, the partition information may include groups without data, shown by “[ ]” in the figure. For example, a stegatone may include multiple cells where some cells are not data bearing. The partition information column includes a number for each partition where the number represents the amount of data in the partition, such as where a partition with “[ ]” representing no data includes partition information 0 for the particular partition. For example, the first authentication string ABEBDEDCABAB includes 9 partitions, and the first partition includes 3 pieces of data. In one implementation, the processor determines partition information associated with authentication data and determines authentication information associated with the determined partition information.

In one implementation, the processor determines authentication information about the authentication string based on the difference between the received partition information and stored partition information, such as a partition key. The difference may be determined as a Hamming distance between the stored partition information and the received partition information. As an example, the first data row in block 300 includes partition information “3 0 2 0 0 1 1 2 3”, Stored partition information may include 9 partitions with the amount of data in the partitions represented by “2 1 2 0 0 1 1 2 3” such that the stored partition information includes the same number of partitions and the same amount of data, but the partition information from block 300 includes a different amount of data in the first two partitions than the stored partition key. The Hamming distance between the two sets of partition information is 2 because two of the nine partitions differ in the number of bits carried by 1 (and the sump |3−2|+0−1|=2).

Referring back to FIG. 2 and continuing to 201, a processor determines authentication information related to the content of the authentication data. For example, the content may be compared to stored accepted authentication keys to determine the difference between the received content and stored keys. The data content may be compared to previously authenticated data content to determine a likelihood of authenticity. The processor may perform any suitable procedure to determine the authenticity of the data content, such as decrypting the authentication data and comparing it to stored authentication information.

Moving to 202, a processor determines a likelihood of authenticity of the authentication data based on the authentication information related to the partitions and the authentication information related to the content. The authentication information related to the partitioning and the authentication information related to the content may be used in any suitable manner and in any suitable combination to determine the likelihood of authenticity. The content authentication information and the partition authentication information may be used together. For example, the processor may determine content authentication information in portions of the data determined to have a higher likelihood of authenticity based on the partition information associated with the particular portions. In one implementation, the partition authentication information may be determined for portions of the data where the content is determined to have a likelihood of authenticity above a threshold. The processor may determine the likelihood of authenticity by aggregating the content authentication information and partition authentication information, such as by creating an authenticity score based on adding individual scores related to the two types of information. A likelihood of authenticity may be used to allow for some errors in the authentication string, such as where a string that is 99% likely to be authentic may include a bit printed incorrectly or read incorrectly, such as due to a camera error or printing error.

Proceeding to 203, a processor outputs information related to the likelihood of authenticity. In some implementations, the processor compares the likelihood of authenticity to a threshold and categorizes authentication strings with a likelihood of authenticity above the threshold as authentic. In some implementations, the processor compares multiple measurements of the likelihood of authenticity. The likelihood of authenticity and/or indication as to whether the authentication string is categorized as authentic may be output. For example, the information may be transmitted, stored, and/or displayed to a user. In one implementation, the processor creates a warning where the authentication data is unlikely to be authentic, such as due the likelihood of authenticity being below a threshold.

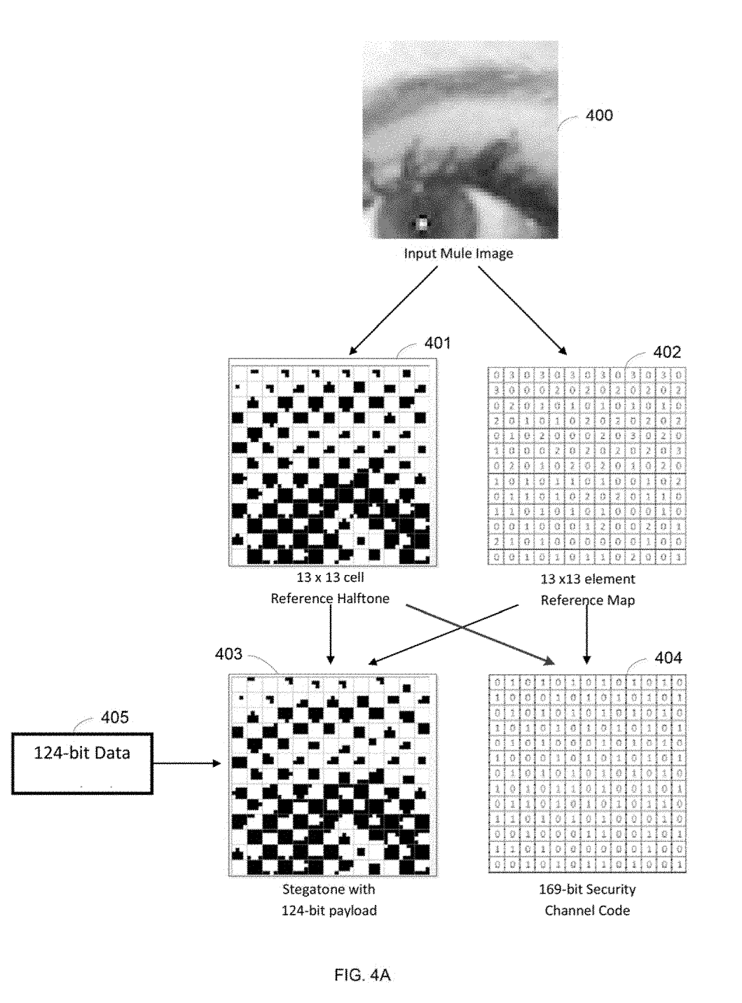

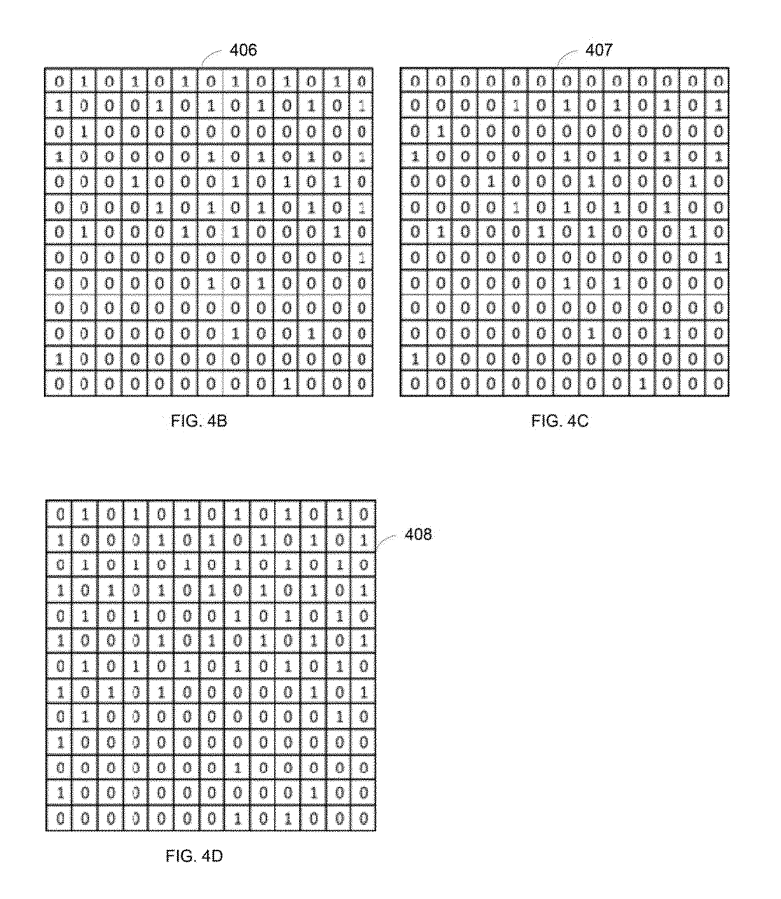

FIG. 4A is a block diagram illustrating one example of data partitions in a stegatone image. For example, a stegatone image may include multiple cells. Each of the cells may be data bearing or non-data bearing. A cell that includes data may include different amounts of data, such as 1, 2, or 3 bits. As an example, the authentication string may be 10001 where the cells can represent two partitions “10” and “001”. The halftone may further include partitions, represented by non-data bearing cells, with no data. For example, the cells may include 10, no data, no data, 001 such that partitioning information is determined to be 1 0 0 1 to reflect which cells include data and/or 2 0 0 3 to reflect both which cells store data and the amount of data in each of the data bearing cells. Any suitable partitioning information about the stegatone data may be used to determine the authenticity of the data included within the stegatone image. The partitioning information may be in the form of a grid representative of the cell based structure of a stegatone.

Block 400 shows an image used to create a stegatone. For example, the stegatone may be a halftone image of the image 400 where the halftone image includes additional data based on the positioning of the black and white dots of the halftone image. For example, the halftone image 401 may be a halftone image of the image 400 such that the halftone image 401 appears similar to the image 401. The mapping 402 may include partition information associated with the cells of the halftone image. For example, the mapping 402 shows the reference map where each of the numbers in the cells indicates the amount of data to be included within the cell. The data capacity of the stegatone is found by summing all the cells of the reference map 402.The data capacity in the example is 124 bits.

The mapping 404 shows a second mapping of the halftone image 401 such that the cells include a 1 where data is included within the cell and the cells include a 0 where no data is to be included within the cell. For example, the mapping 404 may be considered a security channel code because it involves a second channel of data within the image. The security channel information for determining partitioning information associated with authenticity may be based on any non-data specific aspect to the halftone image. Mapping 402 and/or mapping 404 may be used to determine the likelihood of authenticity of a received halftone image. In one implementation, the likelihood of authenticity is determined both on the correct assignment of data bearing cells and the correct amount of data in the data bearing cells. In one implementation, the factors are weighted separately such that one is given more weight than the other.

The stegatone 403 shows the halftone image 401 with the 124 bits of payload data 405 included within the halftone image. A processor may analyze the stegatone 403 to determine a likelihood of authentication based on whether the underlying data is partitioned in the same manner or as similarly to the mappings 402 and 404. A processor may further analyze the data content in the cells to determine a likelihood of authentication.

FIGS. 4B-4D illustrate examples of partition mappings that may be compared to the stegatone 403 to determine likelihood of authenticity. For example, security channel code 406of FIG. 4B representing a map of the partitions has a 1 in cells where the cells include 1 bit of data. Security channel code 407 of FIG. 4C has a 1 in cells where the cells include 2 bits of data. The security channel code (ex. 404, 406, 407, 408) can be any combination of non-data-dependent aspects of the reference halftone 401 and reference map 402. The security channel code 408 of FIG. 4D is one such example. In this case, the 1s correspond to cells that are both carriers and highlight cells. Highlight cells are cells comprised of clusters of black pixels surrounded by white.

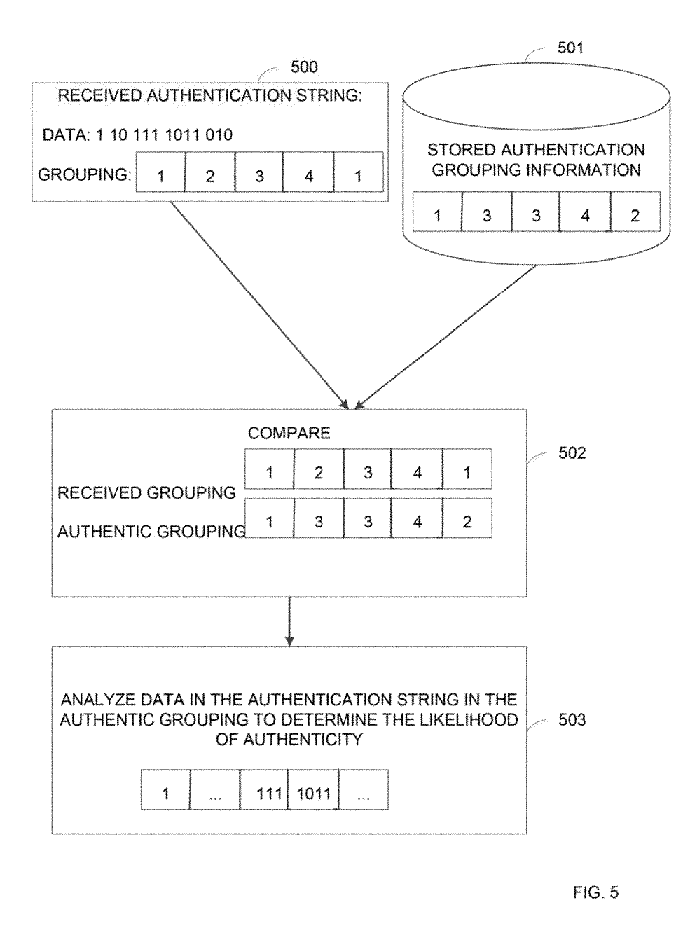

FIG. 5 is a diagram illustrating one example of determining a likelihood of authenticity based on stored partition authentication information. For example, block 500 shows an authentication string with 11 bits partitioned into 5 partitions. The storage 501 shows stored authentication partition information used to determine the likelihood of authenticity. The stored authentication partition information may be a partitioning expected from an authentic string. In some cases, there may be multiple potential authentic partitions. The received string may be compared to the expected partitioning and any deviation from the expected partitioning may be used to determine the likelihood of authenticity of the authentication string. The stored partition information may be in an array format as shown in FIG. 4A security channel mapping 404.

Block 502 shows the received authentication string partition information compared to the stored authentication partition information. The received authentication string includes the correct number of partitions but with some of the partitions having an incorrect number of bits. For example, both the expected partitioning and the received partitioning include 5 partitions, but the second and fifth partitions include different numbers of bits than one another. Block 503 shows an analysis of the partitions of the received string with the expected number of bits. For example, the content of the data within the partitions with the expected number of bits may be analyzed to determine the likelihood of authenticity of the authentication string.

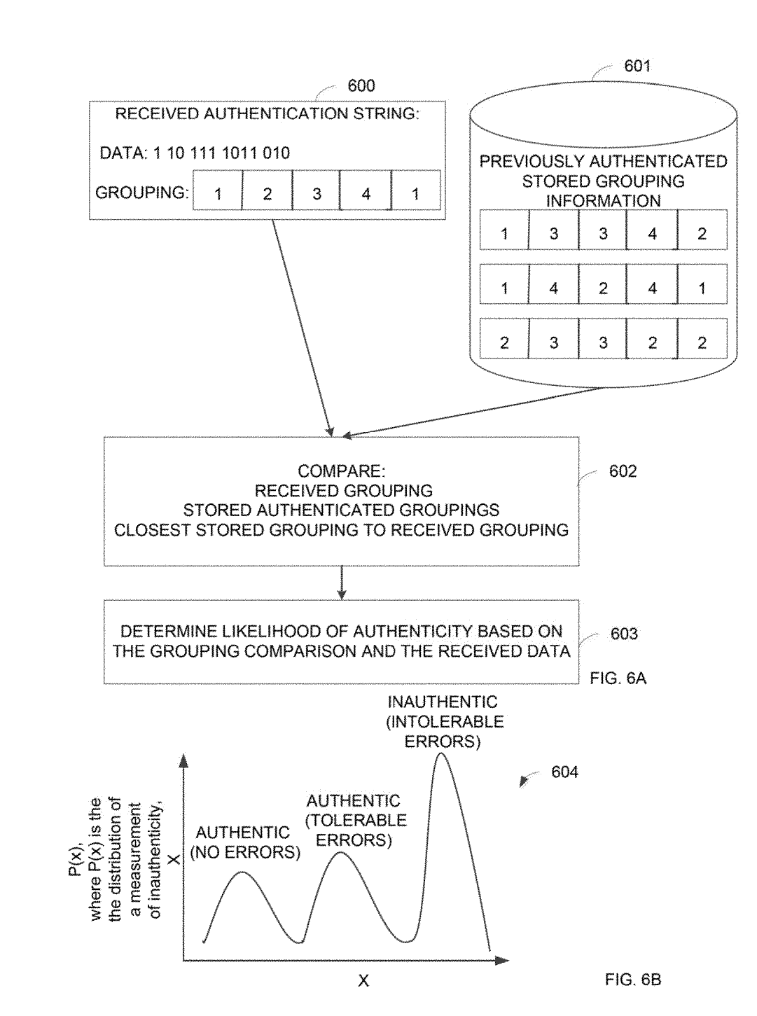

FIG. 6A is a diagram illustrating one example of determining a likelihood of authenticity based on data partitions of stored previously authenticated partition information. For example, the entity performing the authenticating may not be aware of the expected partitioning. Partition information associated with previously authenticated strings may be compared to a received authentication string. Block 600 shows an authentication string with the data and data partition. Block 601 shows partition information related to previously authenticated strings. For example, strings with five partitions of 1, 3, 3, 4, and 1 bits may have been previously authenticated. In one implementation, additional information may be stored, such as the number or percentage of authenticated strings with the particular partition. At block 602, the received data string partition is compared to the closest partition in the storage. Closeness may be determined as a function of structure, time, or any other valid property. The comparison may be based on the number and/or, size of the partitions. At block 603, a processor determines a likelihood of authenticity based on the content of the received string and the comparison to the closest partition in the storage 601,

FIG. 6B is a diagram illustrating one example of determining a likelihood of authenticity based on an error rate. For example, the error rate may be determined based on the bit distribution, such as based on the percentage of partitions including a particular number of bits. A processor may compare partition information related to a received authentication string to partition information associated with previously authenticated data. Determining the authentication information related to partitioning of data may involve determining a likelihood of authenticity using an error rate determined by the percentage of partitions with a particular amount of data for each possible amount of data. For example, an error rate of the amount of data per partition may be estimated as the following:

1−Σᵢ₌₁^{max number of bits/partition}p²(i),

where p(i) is the normalized percentage of matching partitions containing i bits of data. If p(1)=p(2)=p(3)=1/3, the estimated error rate is 0.667. If p(1)=0.5, p(2)=p(3)=0.25, the error is estimated to be 0.625. Any suitable normalization or matching criteria can be used for this purpose. The error rate may be used to determine a likelihood of authenticity. Graph 604 shows an example of determining the likelihood of authenticity based on an error rate associated with the distribution of bits in partitions of previously authenticated data.

A processor may determine a likelihood of authenticity of an authentication string in any suitable comparison to the authenticated partitions. For example, the processor may compare a Hamming distance between the received partition information and partition information associated with a stored authentication string and a Hamming distance between the received string and the stored authentication string. The processor may determine the number of mismatches based on the two sets of Hamming distances from each of the stored authentication strings as a proxy for a degree of inauthenticity. In one implementation, the processor determines the degree of authenticity based on the distribution of Hamming distances of the partition information and data from the received authentication string. Determining a likelihood of authenticity based on both data partitions and data content may allow for a second security channel in a limited authentication space, such as in a data bearing image where the amount of authentication data is limited.

1. A computer system, comprising:
a processor to:
determine partition authentication information related to partitions of authentication data;
determine content authentication information related to the content of the authentication data;
determine a likelihood of authenticity of the authentication data based on the partition authentication information and the content authentication information; and
output information related to the likelihood of authenticity.

2. The computing system of claim 1, wherein determining partition authentication information comprises determining authentication information based on at least one of:
the number of partitions of the authentication data; and
the amount of data in the partitions of the authentication data.

3. The computing system of claim 1, further comprising a storage to store partition information including least one of:
a key for the number of partitions;
a key for the amount of data in each of a number of partitions; and
partition information related to previously authenticated authentication data;
wherein determining partition authentication information comprises determining a Hamming distance between the stored partition information and partitions of the authentication data.

4. The computing system of claim 1, wherein the authentication data is in the form of at least one of: a two-dimensional color barcode, progressive barcode, steganographic halftone, grid code, and digital document.

5. The computing system of claim 1, wherein determining the content authentication information comprises determining authentication information related to the content of data within partitions determined to be likely to be authentic based on the partition authentication information.

6. A method, comprising:
determining, by a processor, authentication information related o partitions of authentication data;
determining authentication information related to the content of the authentication data;
determining a likelihood of authenticity of the authentication data based on the authentication information related to the partitions and the authentication information related to the content; and
outputting information related to the likelihood of authenticity.

7. The method of claim 6, wherein determining authentication information related to partitions of the data comprises determining authentication information based on at least one of: the number of data partitions and the amount of data within the partitions.

8. The method of claim 6, wherein determining authentication information related to partitions of the authentication data comprises determining a Hamming distance between stored partition information and partition information related to the authentication data.

9. The method of claim 6, wherein the authentication information related to partitions of the authentication data is determined based on a Hamming distance between partition information related to the authentication data and stored partition information related to previously authenticated data.

10. The method of claim 6, wherein determining authentication information related to partitions of the authentication data comprises selecting partitions of the authentication data with an amount of data determined to be likely to be authentic, and wherein determining authentication information related to the content of the authentication data comprises determining the likelihood of authenticity of data within the selected partitions.

11. The method of claim 6, wherein determining authentication information related to partitions of authentication data comprises determining authentication information based on at least one of:
the position of data bearing cells in a steganographic halftone; and
the amount of data within the data bearing steganographic halftone cells.

12. A machine-readable non-transitory storage medium comprising instructions executable by a processor to:
determine the likelihood of authenticity of authentication data based on partitions of the authentication data and content of the authentication data; and
output information related to the likelihood of authenticity.

13. The machine-readable non-transitory storage medium of claim 12, wherein instructions to, determine the likelihood of authenticity comprise determining the likelihood of authenticity based on at least one of: the number of partitions within the authentication data and the amount of data in the partitions.

14. The machine-readable non-transitory storage medium of claim 12, wherein instructions to determine the likelihood of authenticity comprise determining the likelihood of authenticity based on at least one of:
a comparison of partition information related to the authentication data to stored authentication partition information; and
a comparison of partition information related to the authentication data to stored information related to partitions of previously authenticated data.

15. The machine-readable non-transitory storage medium of claim 12, wherein the authentication data is in the form of a data bearing image.
